(19) United States
(12) Patent Application Publication
(10) Pub. No.: US 2012/0278604 A1
(43) Pub. Date: Nov. 1, 2012

(54) CONTROL METHOD APPLIED TO COMPUTER SYSTEM IN HYBRID SLEEP MODE

(75) Inventors: Fu-Hsiang Liu, Taipei (TW); Cheng-Chieh Huang, Taipei (TW); Chi-Juin Luo, Taipei (TW)

(73) Assignee: ASUSTeK COMPUTER INC., Taipei (TW)

(21) Appl. No.: 13/454,260

(22) Filed: Apr. 24, 2012

(30) Foreign Application Priority Data
Apr. 27, 2011 (TW) 100114730

(51) Int. Cl. G06F 1/32; G06F 9/00

(52) U.S. Cl. 713/2; 713/323

(57) ABSTRACT

A control method applied to a computer system in a hybrid sleep mode is provided. The control method includes following steps: entering a first sleep mode of the computer after a system parameter is stored in a memory and a hard drive of the computer system; determining whether the computer system is resumed or not in a predetermined first period in the first sleep mode, if true, resuming the computer system by reading the system parameter from the memory; if false, entering a second sleep mode of the computer system; determining whether the computer is resumed or not in the second sleep mode; if true, resuming the computer system by reading the system parameter from the hard drive; and if false, keeping the computer system in the second sleep mode.

This application claims the benefit of Taiwan application Serial No. 100114730, filed Apr. 27, 2011, the subject matter of which is incorporated herein by reference.

### BACKGROUND OF THE INVENTION

1. Field of the Invention

The invention relates to a control method applied to a computer system in a sleep mode and, more particularly, to a control method applied to a computer system in a hybrid sleep mode.

2. Description of the Related Art

Conventionally, sleep modes of a computer system saves power consumption. In other word, when a computer system does not be used for a long time, the computer system enters the sleep mode automatically. In practice, the sleep mode can be divided to the sleep mode S3 and the sleep mode S4 according to power saving level.

FIG. 1 is a schematic diagram showing a conventional computer system. A computer system 100 includes a central processing unit (CPU) 110, a control chip set 120, a memory 130, a hard drive 140, an embedded controller 150, a power switch 160, a keyboard 170, and a flash memory 180. The control chip set 120 includes a north bridge chip 122 and a south bridge chip 126, and the north bridge chip 122 further includes a memory controller 124.

The CPU 110 is connected to the north bridge chip 122 via a front side bus, the memory controller 124 of the north bridge chip 122 is connected to the memory 130 via a memory bus. The south bridge chip 126 is connected to the north bridge chip 122 via a private bus, and is connected to the embedded controller 150 via a low pin count interface. The private bus may be a direct media interface (DMI) bus. Moreover, the embedded controller 150 is connected to the power switch 160, the keyboard 170, and the flash memory 180.

The embedded controller 150 of the computer system 100 can control the supply of the power. That is, the embedded controller 150 can control the supply of the power and provide power to a part of electronic components according to different sleep modes.

FIG. 2 is a schematic diagram showing the supply of power of the computer system in a sleep mode S3. Shadow area represents the area without the supply of power. When the computer system 100 enters the sleep mode S3, the embedded controller 150 starts to control the entry process to the sleep mode S3. The CPU 110 should store all of the system parameters to the memory 130, and the embedded controller 150 records the sleep mode S3 in the flash memory 180. Then, the embedded controller 150 stops power supply to the CPU 110 and a part of the north bridge chip 122.

Furthermore, when the computer system 100 is resumed from the sleep mode S3, the user can press keys of the keyboard 170 or the power switch 160. The embedded controller 150 starts resume process of the sleep mode S3 according to the sleep mode S3 recorded in the flash memory 180. At the time, the embedded controller 150 provides power to the CPU 110 and the north bridge chip 122 again. Then, the CPU 110 uses the memory controller 124 of the north bridge chip 122 to read the system parameter in the memory 130 and resumes the computer system 100 successfully.

FIG. 3 is a schematic diagram showing the supply of power of the computer system in a sleep mode S4. Shadow area represents the area without the supply of power. When the computer system 100 enters the sleep mode S4, the embedded controller 150 starts to control the entry process to the sleep mode S4. The CPU 110 should store all of the system parameters to the hard drive 140, and the embedded controller 150 records the sleep mode S4 in the flash memory 180. Then, the embedded controller 150 stops power supply to the CPU 110, the north bridge chip 122 , the memory 130 , the south bridge chip 126 , the hard drive 140 , the keyboard 170 , the embedded controller 150 and the flash memory 180. Consequently, after the computer system 100 enters the sleep mode S4, the power is only supplied to the power switch 160.

Furthermore, when the computer system 100 is resumed from the sleep mode S4, the user can press the power switch 160 to supply power to the embedded controller 150 and the flash memory 180. The embedded controller 150 starts the resume process of the sleep mode S4 according to the sleep mode S4 recorded in the flash memory 180. The embedded controller 150 provides power to the south bridge chip 126, the north bridge chip 122, the hard drive 140 and the memory 130 again. Finally, power is supplied to the CPU 110, and the CPU 110 uses the south bridge chip 126 to read the system parameter of the hard drive 140 and resumes the computer system 100 successfully.

As stated above, in the sleep mode S4, the power is only supplied to the power switch continuously, the power supply to other electrical elements stops so as to achieve the best power saving effect.

Taking a computer system as an example, it is assumed that the computer system 100 only uses a battery for power supply. When the computer system enters the sleep mode S3, since the power is still continuously supplied to many electrical elements (such as the south bridge chip 126 and the north bridge chip 122), the battery power is continuously consumed.

When the embedded controller 150 detects that the battery is at low power, in order to prevent the system parameter of the memory 130 from being lost due to power off, the embedded controller 150 resumes the computer system 100 automatically to make the computer system 100 reenter the sleep mode S4 and stores the system parameter to the hard drive 140 to save power. However, when the computer system 100 executes the process above, the user does not know. If the user is in walking or driving, the hard drive may be damaged and the system parameter may be lost.

### BRIEF SUMMARY OF THE INVENTION

A control method applied to a computer system in a hybrid sleep mode is provided. The control method includes following steps: entering a first sleep mode of the computer after system parameters are stored in a memory and a hard drive of the computer system; determining whether the computer system is resumed or not in a predetermined first period in the first sleep mode, if true, resuming the computer system by reading the system parameter from the memory; if false, entering a second sleep mode of the computer system; and determining whether the computer is resumed or not in the second sleep mode, if true, resuming the computer system by reading the system parameter from the hard drive; and if false, entering the second sleep mode of the computer system.

These and other features, aspects and advantages of the present invention will become better understood with regard to the following description, appended claims, and accompanying drawings.

### BRIEF DESCRIPTION OF THE DRAWINGS

FIG. 1 is a schematic diagram showing a computer system;

FIG. 2 is a schematic diagram showing the supply of power of the computer system in a sleep mode S3;

FIG. 3 is a schematic diagram showing the supply of power of the computer system in a sleep mode S4;

FIG. 4 is a schematic diagram showing the supply of power of the computer system in a hybrid sleep mode; and

FIG. 5 is a flowchart showing a control method of a hybrid sleep mode in an embodiment.

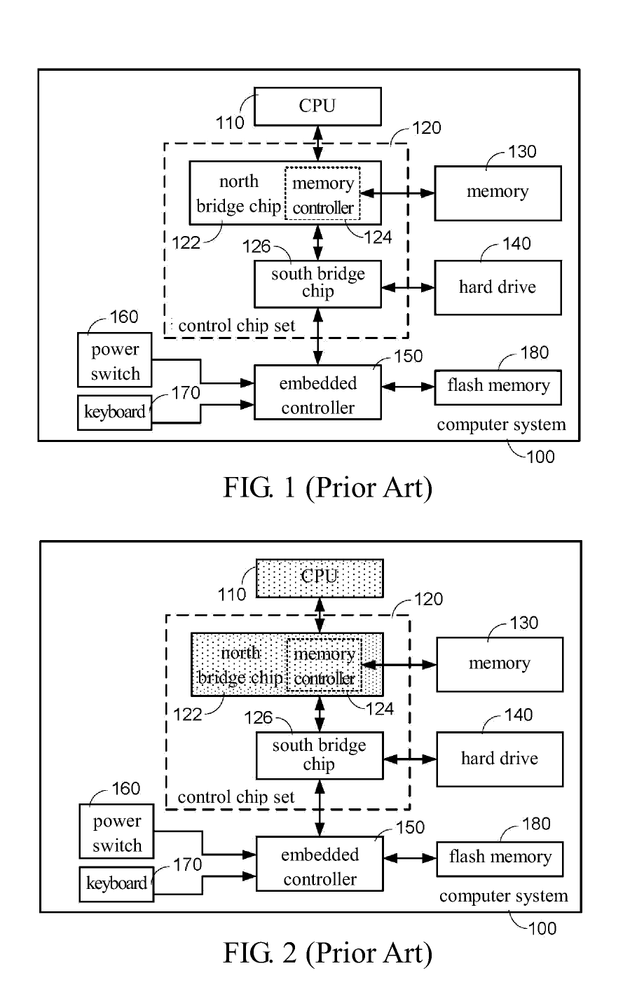

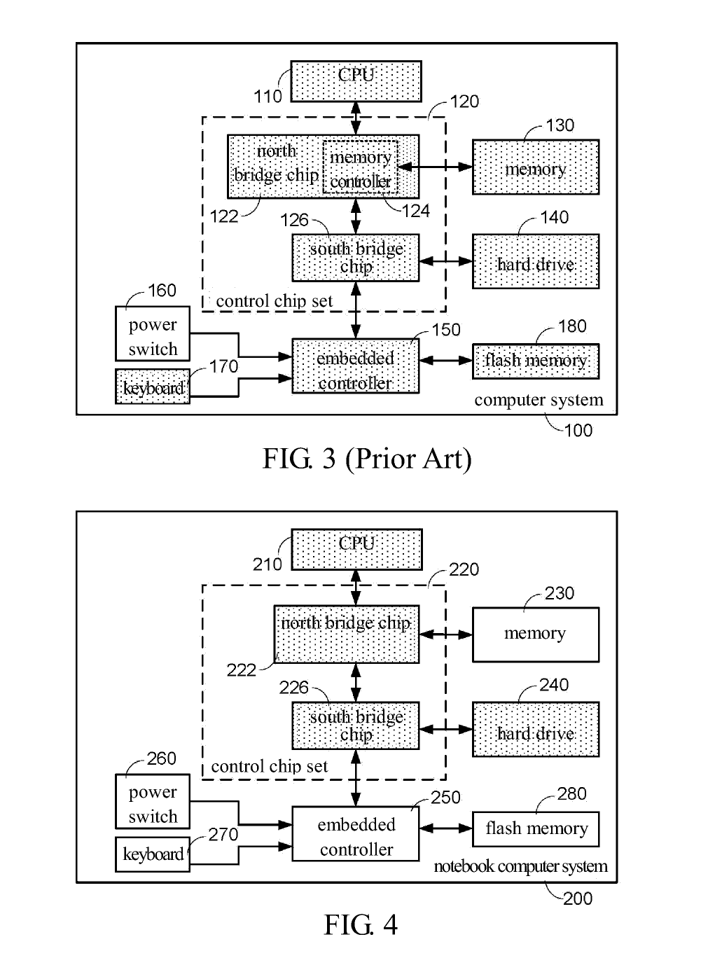

### DETAILED DESCRIPTION OF THE EMBODIMENTS

FIG. 4 is a schematic diagram showing the supply of power of the computer system in a hybrid sleep mode. The shadow area represents the area without the supply of power. The user may select the hybrid sleep mode in computer management option of the operating system. That is, when the computer system enters the sleep mode, it can enter the hybrid sleep mode directly.

When the computer system 200 receives a power saving command (for example, the user inputs a command for the computer to enter the sleep mode for power saving or the user gives no command for a certain period), the embedded controller 250 starts the entry process of the hybrid sleep mode. The CPU 210 would store all of the system parameters to the memory 230 and the hard drive 240, and the embedded controller 250 records the hybrid sleep mode to the flash memory 280. Then, the embedded controller 250 stops supplying power to the CPU 210, the north bridge chip 222, the south bridge chip 226 and the hard drive 240, and the computer system 200 enters the hybrid sleep mode. Consequently, after the computer system 200 enters the hybrid sleep mode, the power are supplied to the memory 230, the embedded controller 250, the flash memory 280, the keyboard 270 and the power switch 260 continuously.

Moreover, the user may press the keys of the keyboard 270 or the power switch 260 to resume the computer system 200 in the hybrid sleep mode, and the embedded controller 250 starts the resume process from the hybrid sleep mode according to the hybrid sleep mode recorded in the flash memory 280. At the time, the embedded controller 250 supplies power to the south bridge chip 226, the hard drive 240 and the north bridge chip 222 again. Then, after the CPU 210 receives power, it uses the north bridge chip 222 to read the system parameter of the memory 230, and resumes the computer system 200 successfully.

In the resume process from the hybrid sleep mode, the CPU 210 reads the system parameter from the hard drive 240 only when the system parameter in the memory 230 is damaged or lost. Otherwise, the CPU 210 reads the system parameter from the memory 230 to resume the computer system 200.

The hybrid sleep mode can prevent the hard drive from being damaged. Taking a notebook computer system as an example, it is assumed that the computer system 200 only use a battery as power supply. When the computer system 200 enters the hybrid sleep mode, since the power also supplied to many electric components (such as the memory 230 and the embedded controller 250) continuously, the battery power is continuously consumed.

When the embedded controller 250 detects that the battery has low power, the embedded controller 250 can switch from the hybrid sleep mode to the sleep mode S4 instantly, and does not need to resume the computer system 200 again. Thus, the hard drive would not be damaged, and the system parameters would not be lost in switching from the sleep mode S3 to the sleep mode S4.

That is, when the computer system 200 switches to the sleep mode S4 directly, even though the system parameters in the memory 230 would be lost, the hard drive 240 also stores system parameters. Consequently, even though the power is only supplied to the power switch 260 of the computer system 200 continuously, the computer system 200 also can be resumed from the sleep mode S4 successfully.

Since the computer system 200 switches from the hybrid sleep mode to the sleep mode S4 only when it detects that the battery is at low power, the continuous battery power consumption cannot be avoided. Thus, a control method of the hybrid sleep mode is further provided.

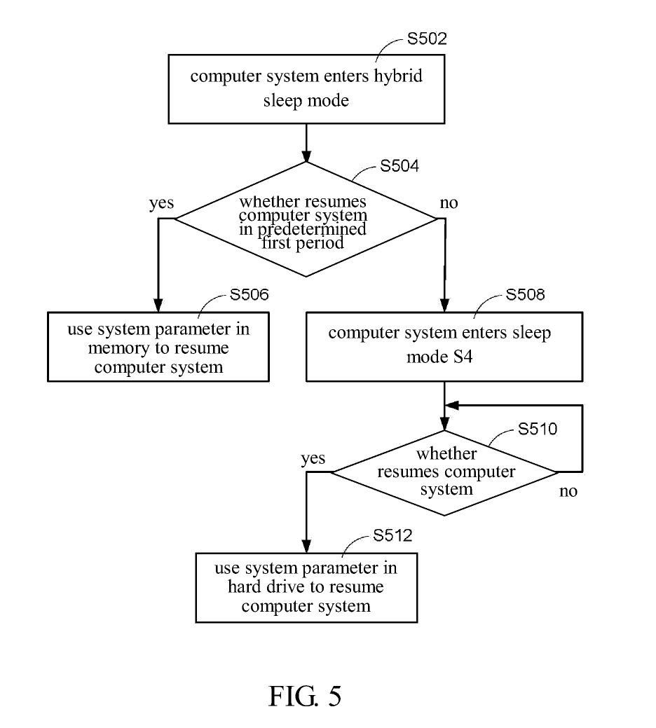

FIG. 5 is a flowchart showing a control method of a hybrid sleep mode in an embodiment of the invention. The user can set the computer system 200 to enter the hybrid sleep mode when it enters the sleep mode, and the user can set a first period such as ten minutes.

Consequently, when the computer system 200 enters the hybrid sleep mode (Step S502), the system parameter is stored in the memory 230 and the hard drive 240. The embedded controller 250 starts timing and determines whether the user resumes the computer system 200 in the predetermined first period (Step S504). If true, the system parameter in the memory 230 is used to resume the computer system 200 (Step S506); if false, the embedded controller 250 makes the computer system 200 enter the sleep mode S4 directly after the first period (Step S508). Then, whether the user resumes the computer system 200 is determined (Step S510). If false, the computer system 200 remains in the sleep mode S4; if true, the system parameter of the hard drive 240 is used to resume the computer system 200 (Step S512).

As stated above, the embedded controller 250 can make the computer system 200 enter the sleep mode S4 directly after the predetermined first period. Thus, the computer system 200 does not need to switch to the sleep mode S4 only when the battery is at low power. As a result, it consumes less power in the hybrid sleep mode, and the standby time of the computer system 200 can be extended.

Though a notebook computer system is taken as an example in the embodiment, the control method can also be applied to a desktop computer system or a tablet computer system. Furthermore, the first period can be set in a basic input/output system (BIOS) of the computer system or selected by the user via an application program.

Although the present invention has been described in considerable detail with reference to certain preferred embodiments thereof, the disclosure is not for limiting the scope of the invention. Persons having ordinary skill in the art may make various modifications and changes without departing from the scope. Therefore, the scope of the appended claims should not be limited to the description of the preferred embodiments described above.

What is claimed is:

1. A control method applied to a computer system in a sleep mode, comprising following steps:
entering a first sleep mode after system parameters is stored in a memory and a hard drive of the computer system;
determining whether the computer system is resumed or not in a predetermined first period in the first sleep mode, if true, resuming the computer system by reading the system parameter from the memory; if false, entering a second sleep mode of the computer system; and
determining whether the computer is resumed or not in the second sleep mode, if true, resuming the computer system by reading the system parameter from the hard drive; and if false, keeping the computer system in the second sleep mode.

2. The control method according to claim 1, wherein the first sleep mode is a hybrid sleep mode.

3. The control method according to claim 2, wherein when a key of a keyboard or a power switch of the computer system is pressed, and the computer system is resumed from the hybrid sleep mode.

4. The control method according to claim 1, wherein the second sleep mode is a sleep mode S4.

5. The control method according to claim 4, wherein when a power switch of the computer system is pressed, and the computer system is resumed from the sleep mode S4.

6. The control method according to claim 1, wherein the computer system is in the second sleep mode, the system parameters in the memory are lost.

7. The control method according to claim 1, wherein the first period is set in a basic input/output system (BIOS) of the computer system or by an application program.

8. The control method according to claim 1, wherein an embedded controller of the computer system is used to calculate the first period.
